(19) United States
(12) Patent Application Publication
(10) Pub. No.: US 2022/0325151 A1
(43) Pub. Date: Oct. 13, 2022

(54) TWO PART CURABLE COMPOSITIONS

(71) Applicant: Henkel AG & Co. KGaA, Duesseldorf (DE)

(72) Inventors: Puwei Liu, Glastonbury, CT (US); Qinyan Zhu, Cheshire, CT (US); Kevin J. Welch, Wallingford, CT (US)

(21) Appl. No.: 17/844,494

(22) Filed: Jun. 20, 2022

Related U.S. Application Data
(63) Continuation of application No. PCT/US2020/065530, filed on Dec. 17, 2020.
(60) Provisional application No. 62/951,554, filed on Dec. 20, 2019.

(51) Int. Cl. C09J 163/00

(52) U.S. Cl. CPC C09J 163/00

(57) ABSTRACT

Two part curable compositions are provided which include a first part comprising a (meth)acrylate component and an amine and a second part comprising a fatty acid peroxide. Further disclosed are methods of preparing a two part adhesive composition using the two part curable compositions and methods of bonding surfaces using the two part curable compositions.

### BACKGROUND

### Field

The present invention provides two part curable compositions which include a first part comprising a (meth)acrylate component and an amine and a second part comprising a fatty acid peroxide.

### Brief Description of Related Technology

Acrylic-based adhesive compositions are well known. See e.g. U.S. Pat. No. 4,536,546 (Briggs). Adhesives based on this technology appear to have been sold under the tradename PLEXUS MA 300 and 310 by Illinois Tool Works Inc., Chicago, Ill. These adhesives can exhibit an obnoxious odor and they are toxic to handle, which may be perceived as significant drawbacks to their use.

U.S. Patent Application Publication No. 2010/0065210 provides a sag-resistant composition including: (a) a first part which includes: (i) a (meth)acrylic component, (ii) an amine catalyst; (iii) an optional second catalyst; (iv) a reactive acid component, and (v) a free-radical inhibitor; and (b) a second part which includes: (i) a resin component which includes epoxy groups, (ii) a peroxide; and (iii) a metal compound which complexes with the strong acid component and which is substantially non-reactive with the peroxide. The first and second parts are of sufficiently low viscosity to be easily dispensed with a pumping apparatus. To form this adhesive, the first and second parts are mixed, and immediately after mixing, the mixture is of a higher viscosity, such that the adhesive does not sag, drip, or migrate, after application to a surface within the open time of the mixture, and the mixed first and second parts cure. By the term “open time” is meant the elapsed time between the mixture of the adhesive to the curing.

U.S. Pat. No. 9,574,118 (Cheng) is directed to an adhesive composition comprising:
(a) a first part comprising:
   (i) a (meth)acrylic component at least a portion of which comprises isobornyl(meth)acrylate;
   (ii) an amine catalyst;
   (iii) a vinyl terminated polybutadiene in liquid form at room temperature;
   (iv) a reactive acid component;
   (v) a solid zinc (meth)acrylate salt;
   (vi) a zinc and/or bismuth complex; and
   (vii) a free-radical inhibitor;
      and
(b) a second part comprising:
   (i) a resin component comprising epoxy groups;
   (ii) a benzoyl peroxide;
   (iii) a plasticizer; and
   (iv) optionally, a block copolymer,
      wherein the first and second parts are mixed and applied to at least one substrate.

U.S. Pat. No. 8,921,490 (Levandoski) is directed to a two-part curable halogen-free composition comprising:
a. a first part comprising:
   i. at least one (meth)acrylate monomer;
   ii. a first halogen-free elastomer, where the first halogen-free elastomer comprises styrene-butadiene-styrene block copolymer;
   iii. an acid catalyst;
   iv. a free radical initiator; and
   v. a free radical stabilizer; and
b. a second part comprising:
   i. at least one (meth)acrylate monomer;
   ii. a second halogen-free elastomer;
   iii. a catalyst; and
   iv. a stabilizer for stabilizing said catalyst;
      where the first part and the second part are combined together to form a curable composition.

U.S. Pat. No. 6,433,091 (Cheng) is directed to a (meth)acrylate ester-containing two-part reactive adhesive composition including vinyl-terminated liquid rubber and polymeric elastomer. The vinyl-terminated liquid rubber is preferably (meth)acrylate-terminated polybutadiene; the polymeric elastomer is preferably polychloroprene, core shell polymer and/or block copolymer rubber.

U.S. Pat. No. 6,291,593 (Cheng) is directed to an adhesive composition consisting essentially of 10-90 weight percent ester monomer, about 2-85 weight percent polymeric elastomer, about 0.02-10 weight percent initiator, and about 0.005-7 weight percent of a retarding additive, the retarding additive being selected from the group consisting or non-protonic Lewis acids and zinc salts and mixtures thereof, the ester monomer being selected from the group consisting of methacrylate ester monomers, acrylate ester monomers and mixtures thereof, said retarding additive being present in an amount effective to (a) extend the open time of the adhesive composition at least five minutes or (b) reduce the peak exotherm temperature of the adhesive composition at least 15° F.

U.S. Pat. No. 9,657,203 (Murray) is directed to a two part curable composition where the composition comprises:
(a) a first part comprising:
   (i) a (meth)acrylate component;
   (ii) 1,4-quinones, such as napthoquinone or benzoquinone and derivatives thereof in an amount less than or equal to about 0.05 percent by weight;
   (iii) triaryl or alkaryl phenylphosphine in an amount greater than or equal to about 0.5 percent by weight; and
   (iv) an amine;
      and
(b) a second part comprising:
   (i) benzoyl peroxide in an amount greater than about 1.0 percent by weight.

The composition of the '203 patent is reported to have an open time at room temperature of at least about 2 minutes and a fixture time of less than about 80 seconds at a bondline temperature of 40° C. when used to adhesively join substrates, such as dissimilar ones where one of which is constructed from a plastic like PC/ABS and the other is constructed from a metal like anodized aluminum. The composition of the '203 patent is reported to have a shelf life at a temperature of 38° C. of greater than 4 weeks.

And International Patent Publication No. WO 2017/172270 (Messana) is directed to a two part curable composition comprising:

Part A: one or more compounds within structure I below:

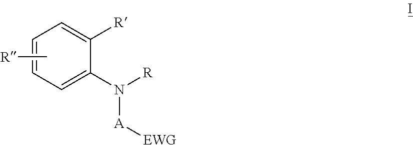

wherein A is CH₂ or benzyl, R is C₁₋₁₀ alkyl, R′ is H or C₁₋₁₀ alkyl, or R and R′ taken together may form a four to seven membered ring fused to the benzene ring, R″ is optional, but when R″ is present, R″ is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl, and EWG is an electron withdrawing group; and

Part B: an oxidant,

wherein at least one of Part A or Part B comprises a (meth)acrylate component.

Notwithstanding the state of the art, existing compositions do not possess the desired combination of long open time properties and sharp cure features desired for many assembly applications. Accordingly, a need exists for such a composition.

That need remained unfulfilled, until now.

### SUMMARY

A two part curable composition is provided in one aspect, where the composition comprises:
(a) a Part A composition comprising:
   (i) a (meth)acrylate component; and
   (ii) an amine;
and
(b) a Part B composition comprising:
   (i) a fatty acid peroxide.

When the Part A composition and the Part B composition are mixed together at room temperature (i.e., room temperature being about 25° C.) the mixed composition demonstrates at least about 3 hours of open time and yet reaches its peak cure temperature (or, T_{PEAK}) in less than about one hour thereafter, as measured by a PICO Technologies USB TC-08 thermocouple data logger.

In another aspect, the present invention provides a method of improving the open time of two part curable compositions and sharpening the time difference between the temperature at which the onset of cure begins and the peak cure temperature is reached.

### BRIEF DESCRIPTION OF THE FIGURE

FIG. 1 depicts a plot of cure temperature over time as captured by a PICO Technologies USB TC-08 thermocouple data logger.

### DETAILED DESCRIPTION

As noted above, the inventive compositions include a Part A composition comprising a (meth)acrylate component and an amine and a Part B composition comprising a fatty acid peroxide.

When the Part A composition and the Part B composition are mixed together at room temperature (i.e., room temperature being about 25° C.) the mixed composition demonstrates at least about 3 hours of open time and yet reaches its peak cure temperature (or, T_{PEAK}) within about less than one hour thereafter, as measured by a PICO Technologies USB TC-08 thermocouple data logger.

### Part A

### (Meth)Acrylate Component

Any suitable material that contains at least one group having the following formula:

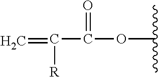

where R here is selected from H or C₁ alkyl may be used.

Advantageously, the group is a (meth)acrylate or (meth)acryloxy group, which is intended to refer to both acrylate and methacrylate, in which R is H or methyl, respectively. The useful amount of the (meth)acrylate component typically ranges from about 20 percent by weight to about 80 percent by weight of the total composition. Desirably, the inventive compositions contain from about 50 percent by weight to about 70 percent by weight of a (meth)acrylate component. In some embodiments, at least a portion of the (meth)acrylate component is isobornyl (meth)acrylate. For instance, about 5 percent by weight to about 35 percent by weight of the inventive composition should be isobornyl (meth)acrylate.

The (meth)acrylate component may be present in the form of a polymer, a monomer, or a combination thereof. When present in the form of a polymer, the (meth)acrylate component may be a polymer chain to which is attached at least one of the (meth)acrylate or (meth)acryloxy groups. The groups may be located at a pendant or a terminal position of the backbone, or a combination thereof.

Advantageously, at least two such groups may be present, and may be located at terminal positions. The (meth)acrylate component may have a polymer chain, constructed from polyvinyl, polyether, polyester, polyurethane, polyamide, epoxy, vinyl ester, phenolic, amino resin, oil based, and the like, as is well known to those skilled in the art, or random or block combinations thereof.

The polymer chain may be formed by polymerization of vinyl monomers. Illustrative examples of such vinyl monomers are methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(meth)acryloyloxypropyltrimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentaacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate and ethoxylated bisphenol A di(meth)acrylate. These monomers may be used each alone or a plurality of them may be copolymerized.

Particularly desirable are {meth)acrylate ester monomers including those where the alcohol portion of the ester group contains C₁₋₈. For instance, 2-ethylhexyl methacrylate, hydroxyethyl methacrylate, cyclohexyl methacrylate, ethyl methacrylate, 1,3-butanedioldimethacrylate (“BDMA”), butyl methacrylate and methyl methacrylate (“MMA”), are examples.

The (meth)acrylate component may comprise from about 10 to about 90 percent by weight of the composition, such as about 60 to 90 percent by weight, based on the total weight of the composition.

### Amines

The inventive compositions include at least one amine. The amine(s) act(s) as a catalyst by accelerating or otherwise promoting curing of the inventive compositions. The amines desirably are secondary amines or tertiary amines that are sterically hindered. Suitable amines include, for example, secondary or tertiary amines represented by the formula N—RR₂R₃, where R is selected from hydrogen (in the case of secondary amines) or alkyl (and hydroxy substituted versions thereof), aryl, alkaryl or aralkyl radicals, including C₁₋₁₀ alkyl, C₆₋₁₈ aryl, C₇₋₁₅ alkaryl, and C₇₋₁₅ aralkyl radicals. The R₂ and R₃ groups may be linked so that the nitrogen is embedded within a cyclic structure, which itself may fuse to an aromatic ring system. Otherwise, R₂ and R₃ may each independently be R.

Particularly useful amines for inclusion in Part A of the inventive compositions include amines within structure A

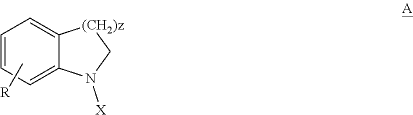

where R is optional but when present may be present 1-4 times and may be chosen from C₁₋₅ alkyl, which may be interrupted by one or more hereto atoms and/or functionalized by halogen, —OH, —COOH, —CN, —NH₂ or —NO₂; halogen; —OH; —COOH; —CN; —NH₂ or —NO₂; X is C₁₋₅ alkyl or C₇₋₂₀ alkaryl, either of which may be interrupted by one or more hereto atoms, and which are functionalized by at least one electron withdrawing groups such as —CN or —NO₂; and z is 1-3.

For instance, amines within structure A may be chosen where X is C₁ alkyl or C₇ alkaryl substituted on the aromatic ring by at least one electron withdrawing group. Examples of such amines include

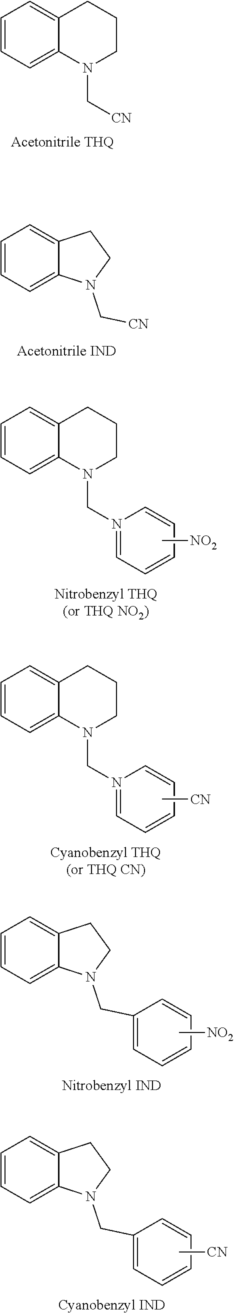

Compounds within structure A may be prepared from

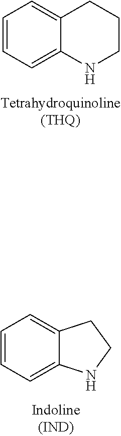 [SMILES: c1ccc2c(c1)CCCN2 ; c1ccc2c(c1)CCN2]

The amine should be present in an amount from about 0.01 percent by weight to about 5 percent by weight. Desirably, the amine is present in an amount from about 0.05 percent by weight to about 2 percent by weight. More desirably, the amine should be present in amount from about 0.3 percent by weight to about 0.7 percent by weight.

### Vinyl-Terminated Polybutadiene

When present, the vinyl-terminated polybutadienes should be in liquid form at room temperature. The vinyl-terminated polybutadienes should have a glass transition temperature below 0° C. The vinyl-termination may be in the form of (meth)acrylate-termination, for instance (meth)acrylate-terminated polybutadiene-acrylonitrile copolymers such as HYCAR VTBN, or (meth)acrylate-terminated polybutadiene, such as HYCAR VTB, each from BF Goodrich. The vinyl-terminated polybutadienes should be present in an amount of up to about 20 percent by weight, such as about 5 percent by weight to about 15 percent by weight.

### Reactive Acid Component

The inventive compositions may include an acid or acid ester as a reactive acid component such as phosphoric acid or derivatives thereof, phosphate acid esters, and sulfonic acids or derivatives. A preferred reactive acid component is a phosphate acid ester.

The acid may be chosen from free-radical polymerizable acids, such as ethylenically unsaturated mono or polycarboxylic acids, maleic acid and crotonic acid. Desirable ones include methacrylic acid (“MAA”) and acrylic acid.

The reactive acid component also modulates and decelerates the curing time of the composition.

Suitable phosphate esters include those represented by the formula:

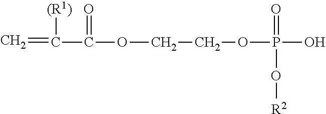

where here R¹ is H or CH₃, and R² is H, or a radical represented by the structure:

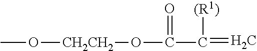

where here R¹ is H or CH₃. A particularly useful phosphate ester is hydroxyl ethyl methacrylate phosphate ester, which is sold under the tradenames T-MULZ 1228 or HARCRYL 1228 or 1228M, each available from Harcros Chemicals, Kansas City, Kans. Also included are structures with at least one strong acid “active hydrogen” group, or with at least one phosphonic acid active hydrogen group (R₁R₂POOH), such as hydroxyl ethyl diphosphonic acid, phosphonic acid, and derivatives, or oligomeric or polymeric structures with phosphonic acid functionality or similar acid strength functionality.

When present, the reactive acid component is present from about 0.25 percent by weight to about 15 percent by weight of the composition. Desirably, where the reactive acid component is a phosphate ester, it is present from about 1.0 to about 4.0 percent by weight of the composition.

### 1,4-Quinones

When present, certain 1,4-quinones may be used to stabilize the inventive compositions.

Naphthoquinone is one such 1,4-quinone; anthroquinone and benzoquinone are others.

Naphthoquinone may be used in the first part of the composition in an amount less than or equal to about 0.005 percent by weight.

Desirably, that amount is less than or equal to about 0.004 percent by weight, such as less than or equal to about 0.0035 percent by weight.

### Aryl Phosphines

When present, an aryl phosphine may be used in the first Part A composition. The aryl phosphine may include tri(o-tolyl)phosphine, tris(4-methoxyphenyl)phosphine, diphenyl(p-tolyl)phosphine, diphenyl(o-tolyl)phosphine, tris(o-methoxyphenyl)phosphine, tri(p-tolyl)phosphine, diphenyl(2-methoxyphenyl)phosphine, tris(3,5-dimethylphenyl)phosphine, and of course triphenylphosphine.

Triphenylphosphine is used in an amount greater than or equal to about 0.5 percent by weight, such as greater than or equal to about 0.75 percent by weight.

### Other Additives

The Part A composition may contain additional additives too, such as fillers, core shell polymers, lubricants, thickeners, and coloring agents. The fillers provide bulk without sacrificing strength of the adhesive and can be selected from high or low density fillers. Also, certain fillers, such as silica, can confer rheological modification or small particle reinforcements. Commercially available examples include Cab-O-Sil 610 and AEROSIL R8200.

Of particular interest are low density fillers, because the resulting final product has an otherwise lower density than a product without the filler, yet has essentially the same strength characteristics as if the filler was not present.

The core shell polymer is desirably a graft copolymer of the “core shell” type, or may also be a “shell-less” cross-linked rubbery particulate, such as acrylonitrile-butadiene-styrene (ABS), methacrylate-butadiene-styrene (MBS), and methacrylate-acrylonitrile-butadiene-styrene (MABS). BLENDEX 338 is an ABS powder from GE Plastics.

### Part B

### Fatty Acid Peroxides

Instead of the now conventional benzoyl peroxide, peroxides like fatty acid peroxides, such as lauroyl peroxide, are desirable choices for use in the second part. In addition to lauroyl peroxide, which has a straight chain C₁₁ alkyl group attached to a carbonyl carbon of the carboxylic acid which forms the peroxide, other fatty acid peroxides may also be used. For instance, fatty acid peroxides with carbon atom chain lengths of 8 to 18 may be used. Of particular interest are those having 9, 11, 14 and 16 carbon atoms attached to the carbonyl carbon of the carboxylic acid which forms the peroxide.

Lauroyl peroxide is shown below:

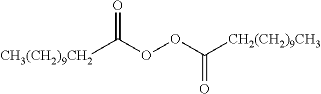

A commercially available example of lauroyl peroxide is sold by Arkema, Inc. under the tradename LUPEROX LP.

Fatty acid peroxides having straight chains of C₉, C₁₄ and C₁₆ are shown below as didecanoyl peroxide, dimyristyl peroxydicarbonate and dicetyl peroxydicarbonate, respectively, and are available commercially from Akzo Nobel NV as members of a product line under the PERKADOX tradename.

The fatty acid peroxide should be present in an amount from about 20 percent by weight to about 60 percent by weight of the Part B composition. Desirably, the fatty acid peroxide is present in an amount from about 25 percent by weight to about 50 percent by weight. More desirably, the fatty acid peroxide should be present in amount from about 35 percent by weight to about 45 percent by weight.

### Epoxy Resins

The epoxy resin is an optional component, but when present may include cycloaliphatic epoxides, epoxy novolac resins, bisphenol-A epoxy resins, bisphenol-F epoxy resins, bisphenol-A epichlorohydrin based epoxy resin, alkyl epoxides, limonene dioxides, and polyepoxides.

A desirable resin component is a cycloaliphatic epoxide sold by Dow Chemical under the brand name CYRACURE UVR-6110.

Another suitable resin component is a bisphenol based liquid epoxy resin, such as those sold under the trade name “D.E.R.” by Dow Chemical. Examples of “D.E.R.” products that are suitable for this invention include D.E.R. 332 (diglycidyl ether of bisphenol-A); D.E.R. 330 (low viscosity, undiluted, bisphenol-A liquid epoxy resin); D.E.R. 383 (low viscosity, undiluted, bisphenol-A liquid epoxy resin); D.E.R. 354 (standard, bisphenol-F based liquid epoxy resin); D.E.R. 351 (low viscosity, liquid bisphenol-A/F resin blend); D.E.R. 352 (low viscosity, liquid bisphenol-A/F resin blend); D.E.R. 324 (aliphatic glycidyl ether reactive diluent, modified liquid epoxy resin); D.E.R. 323 (aliphatic glycidyl ether reactive diluent, modified liquid epoxy resin); D.E.R. 325 (aliphatic glycidyl ether reactive diluent, modified liquid epoxy resin); and D.E.R. 353 (aliphatic glycidyl ether reactive diluent, modified liquid epoxy resin). A different brand of a bisphenol based liquid epoxy resin suitable for use here is EPON 828, derived from bisphenol A and epichlorohydrin, and commercially available from Hexion Specialty Chemicals.

Another suitable resin component is an epoxy novolac resin, which are products of epichlorohydrin and phenol-formaldehyde novolac, and sold under the trade name D.E.N. by Dow Chemical. Examples of “D.E.N.” products that are suitable for this invention include D.E.N. 431 (low viscosity semi-solid epoxy novolac resin); and D.E.N. 438 (semi-solid epoxy novolac resin).

Other suitable epoxy resins include polyepoxides curable with catalyst or hardeners at ambient temperatures or at suitable elevated temperature. Examples of these polyepoxides include polyglycidyl and poly(β-methylglycidyl) ethers obtainable by reaction of a compound containing at least two free alcoholic hydroxyl and/or phenolic hydroxyl groups per molecule with the appropriate epichlorohydrin under alkaline conditions or, alternatively, in the presence of an acidic catalyst and subsequent treatment with alkali. These ethers may be made from acyclic alcohols such as ethylene glycol, diethylene glycol, and higher poly(oxyethylene)glycols, propane-1,2-diol and poly(oxypropylene)glycols, propane-1,3-diol, butane-1,4-diol, poly(oxytetramethylene)glycols, pentane-1,5-diol, hexane-2,4,6-triol, glycerol, 1,1,1-trimethylolpropane, pentaerythritol, sorbitol, and poly(epichlorohydrin); from cycloaliphatic alcohols, such as resorcinol, quinitol, bis(4-hydroxycyclohexyl)methane, 2,2-bis(4-hydroxycyclohexyl)propane, and 1,1-bis(hydroxymethyl)-cyclohex-3-ene; and from alcohols having aromatic nuclei, such as N,N-bis(2-hydroxyethyl)aniline and p,p′-bis(2-hydroxyethylamino)diphenylmethane. Or they may be made from mononuclear phenols, such as resorcinol and hydroquinone, and from polynuclear phenols, such as bis(4-hydroxyphenyl)methane, 4,4′-dihydroxydiphenyl, bis(4-hydroxyphenyl)sulphone, 1,1,2,2-tetrabis(4-hydroxyphenyl)ethane, 2,2,-bis(4-hydroxyphenyl)propane (otherwise known as bisphenol A), 2,2-bis(3,5-dibromo-4-hydroxyphenyl)propane, and novolaks formed from aldehydes such as formaldehyde, acetaldehyde, chloral, and furfuraldehyde, with phenols such as phenol itself, and phenols substituted in the ring by chlorine atoms or by alkyl groups each containing up to nine carbon atoms, such as 4-chlorophenol, 2-methylphenol, and 4-t-butylphenol. Poly(N-glycidyl) compounds include, for example, those obtained by dehydrochlorination of the reaction products of epichlorohydrin with amines containing at least two amino-hydrogen atoms, such as aniline, n-butylamine, bis(4-aminophenyl)methane, and bis(4-methylaminophenyl)methane; triglycidyl isocyanurate; and N,N′-diglycidyl derivatives of cyclic alkylene ureas, such as ethyleneurea and 1,3-propyleneureas, and hydantoins such as 5,5-dimethylhydantoin. Epoxide resins having the 1,2-epoxide groups attached to different kinds of hetero atoms may be employed, such as the N,N,O-triglycidyl derivative of 4-aminophenol, the glycidyl ether-glycidyl ester of salicylic acid, N-glycidyl-N′-(2-glycidyloxypropyl)-5,5-dimethylhydantoin, and 2-glycidyloxy-1,3-bis(5,5-dimethyl-1-glycidylhydantoin-3-yl)propane. Epoxides derived from oils, such as epoxidized soybean oil, epoxidized castor oil, and the like are also suitable. Epoxides derived from or capable of being derived from the per-acid oxidation of unsaturation are also suitable, including epoxidized liquid rubber.

### Plasticizers

Plasticizers are oftentimes used in the Part B composition of the two part composition. Plasticizers may also be used in the Part A compositions as well. Plasticizers may be any liquid or soluble compound that assists with the flexibility of the reactive module of composition and/or may act as a carrier vehicle for other components of the composition. Examples include aromatic sulfonamides, aromatic phosphate esters, alkyl phosphate esters, dialkylether aromatic esters, polymeric plasticizers, dialkylether diesters, polyglycol diesters, tricarboxylic esters, polyester resins, aromatic diesters, aromatic triesters (trimellitates), aliphatic diesters, epoxidized esters, chlorinated hydrocarbons, aromatic oils, alkylether monoesters, naphthenic oils, alkyl monoesters, paraffinic oils, silicone oils, di-n-butyl phthalate, diisobutyl phthalate, di-n-hexyl phthalate, di-n-heptyl phthalate, di-2-ethylhexyl phthalate, 7c9c-phthalate (linear and branched), diisoctyl phthalate, linear 6c,8c,10c phthalate, diisononyl phthalate, linear 8c-10c phthalate, linear 7c-11c phthalate, diisodecyl phthalate, linear 9c-11c phthalate, diundecyl phthalate, diisodecyl glutarate, di-2-ethylhexyl adipate, di-2-ethylhexyl azelate, di-2-ethylhexyl sebacate, di-n-butyl sebacate, diisodecyl adipate, triethylene glycol caprate-caprylate, triethylene glycol 2-ethylhexanote, dibutoxyethyl adipate, dibutoxyethoxyethyl adipate, dibutoxyethoxyethyl formal, dibutoxyethoxyethyl sebacate, tri-2-ethylhexyl trimellitate, tri-(7c-9c(linear)) trimellitate, tri-(8c-10c(linear)) trimellitate, triethyl phosphate, triisopropyl phenyl phosphate, tributyl phosphate, 2-ethylhexyl diphenyl phosphate, trioctyl phosphate, isodecyl diphenyl phosphate triphenyl phosphate, triaryl phosphate synthetic, tributoxyethyl phosphate, tris(-chloroethyl) phosphate, butylphenyl diphenyl phosphate, chlorinated organic phosphate, cresyl diphenyl phosphate, tris(dichloropropyl) phosphate, isopropylphenyl diphenyl phosphate, trixylenyl phosphate, tricresyl phosphate, or diphenyl octyl phosphate.

### Block Copolymers

When used, the block copolymer may be any block copolymer capable of contributing to the physical properties desired for the disclosed composition.

The block copolymer rubber may be constructed using blocks of either butadiene or isoprene with styrene (for example, SBS, SIS, SEBS and SB), commercial examples of which are available from Shell Chemical Co. as KRATON D-1116 and other KRATON D-grade elastomers from Dexco as VECTOR 2411IP.

Other elastomers with Tg below about 25° C., which are soluble in methacrylate/acrylate monomers, can be used in place of the polychloroprene and/or the block copolymer rubbers. Examples of such are homopolymer of epichlorohydrin and its copolymers with ethylene oxide, available from Zeon Chemicals as HYDRIN, acrylate rubber pellets, available from Zeon as HYTEMP, polyisoprene rubber, polybutadiene rubber, nitrile rubber, and SBR rubber (random copolymer of butadiene and styrene).

Still other block copolymers may be a styrene maleic anhydride copolymer, represented by the formula:

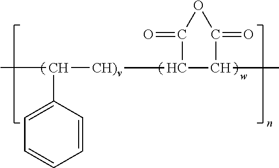

where v is from 1 to 12; w is from 1 to 6; and n is from 1 to 50.

Styrene maleic anhydride copolymers are well known and some of which are available commercially from Sartomer Company, Inc., Exton, Pa. under the trade name SMA EF80, for example. Styrene maleic anhydride copolymers represent the copolymerization product of styrene and maleic anhydride and are characterized by alternating blocks of styrene and maleic anhydride moieties.

Amphiphilic block copolymers may be particularly desirable. Arkema offers for sale commercially an amphiphilic block copolymer under the trademark NANOSTRENGTH. Such block copolymers are currently available in two versions: SBM and MAM. The SBM copolymer is reportedly made of polystyrene, 1,4-polybutadiene and syndiotactic poly(methyl methacrylate).

In addition, a polymer material constructed from polymethyl methacrylate (“PMMA”) and polybutyl acrylate (“PB”) may be used too. Polymer materials within this class are referred to as polymethylmethacrylate-block-polybutylacrylate-block polymethylmethacrylate copolymers (“MAM”).

As reported by Arkema, MAM is a triblock copolymer, consisting of about 70% PMMA and 30% PB. MAM is constructed from distinct segments, which provides for the ability to self-assemble at the molecular scale. That is, M confers hardness to the polymer and A confers elastomeric properties to the polymer.

A hard polymer segment tends to be soluble in (meth)acrylates, whereas the elastomeric segments provide toughness to the polymeric (meth)acrylate, which forms upon cure. MAM also reinforces mechanical properties, without compromising inherent physical properties. MAM is commercially available under the tradename NANOSTRENGTH, at present under several different grades—i.e., E-21 and M-52N.

Arkema promotes the NANOSTRENGTH product line as an acrylic block copolymer that is miscible with many polymers, most of which according to the manufacturer are major industrial epoxy resins. See also U.S. Pat. No. 6,894,113, where in its abstract the '113 patent speaks to a thermoset material with improved impact resistance. The impact resistance is derived from 1 to 80% of an impact modifier comprising at least one copolymer comprising S-B-M, B-M and M-B-M blocks, where each block is connected to the other by a covalent bond or of an intermediary connected to one of the blocks by a covalent bond and to the other block by another covalent bond, M is a PMMA homopolymer or a copolymer comprising at least 50% by weight of methyl methacrylate, B is incompatible with the thermoset resin and with the M block and its glass transition temperature Tg is less than the operating temperature of the thermoset material, and S is incompatible with the thermoset resin, the B block and the M block and its Tg or its melting temperature is greater than the Tg of B.

Another commercially available example of an amphiphilic block copolymer is a polyether block copolymer known to the trade as FORTEGRA 100, from Dow Chemical Co. Dow describes FORTEGRA 100 as a low viscosity toughening agent designed for use as a high efficiency second phase, in amine cured epoxy systems. FORTEGRA 100 is reported to provide improved toughness without significantly affecting the viscosity, glass transition temperature, corrosion resistance, cure rate or chemical resistance of the final coating or composition. FORTEGRA 100 is also reported to be useful for formulation into standard bisphenol A and bisphenol F epoxy systems as it does not participate in the epoxy cure reaction. As a second phase toughening agent, FORTEGRA 100 is promoted as being effective when formulated at a specific volume fraction of the finish film or part, typically 3% to 8% by dry volume is said to achieve the toughening effect.

Additional block copolymers include those which comprise both hydrophobic and hydrophilic segments or portions, of the general formula:

—[(R¹)ᵥ—(R²)_{w}]ₙ—

where here R¹ is independently a hydrophobic olefin, such as ethylene, propylene, 1-butene, 1-hexene, 3-methyl-1-pentene, or 4-methyl-1-pentene or a polymerizable hydrophobic aromatic hydrocarbon such as styrene; each R² is a hydrophilic acid anhydride, such as maleic anhydride; v is from 1 to 12; w is from 1 to 6; and n is from 1 to 50.

The ratio of the hydrophobic segments to the hydrophilic segments in the styrene maleic anhydride block copolymer may be at least 2:1, such as between 3:1 and 12:1. The hydrophilic segments in the block copolymer should comprise an anhydride, such as maleic anhydride. The hydrophobic segments in the block copolymer should comprise at least one of ethylene, propylene, 1-butene, 1-hexene, 3-methyl-1-pentene, 4-methyl-1-pentene, or styrene. Desirably, the block copolymer should be prepared with the hydrophilic segments comprising maleic anhydride and the hydrophobic segments comprising styrene.

Reference to the following patent documents shows amphiphilic block copolymers suitable for use herein, and as such are incorporated herein by reference. U.S. Pat. No. 7,745,535 is directed to and claims an amphiphilic multiblock copolymer where at least one block is a profiled block consisting of a) a hydrophilic middle block made from one or more monomeric units selected from acrylic acid, methacrylic acid, and the salts, esters, anhydrides and amides of acrylic acid and methacrylic acid; dicarboxylic acid anhydrides; carboxyethyl acrylate; and acrylamides; and b) hydrophobic end blocks where the multiblock copolymer is water insoluble, water indispersible, and not soluble or dispersible in C₁₋₃ alcohols.

U.S. Pat. No. 7,820,760 is directed to and claims a curable adhesive epoxy resin composition including (a) an epoxy resin; (b) an amphiphilic block copolymer containing at least one epoxy resin miscible block segments and at least one epoxy resin immiscible block segments (where the immiscible block segment comprises at least one polyether structure provided that the polyether structure of the immiscible block segment contains at least one or more alkylene oxide monomer units having at least four carbon atoms); and (c) at least one curing agent. The amphiphilic block copolymer in the '760 patent is an all polyether block copolymer such as a PEO-PBO diblock copolymer or a PEO-PBO-PEO triblock copolymer. The amphiphilic block copolymer is present in an amount such that when in the '760 patent the epoxy resin composition is cured, the bond strength of the resulting cured epoxy adhesive resin composition increases compared to an epoxy resin composition without the amphiphilic polyether block copolymer.

U.S. Pat. No. 7,670,649 is directed to and claims a curable ambient cure high-solids coating composition including (a) an epoxy resin; (b) an amphiphilic block copolymer containing at least one epoxy resin miscible block segment (where the immiscible block segment comprises at least one polyether structure provided that the polyether structure of the immiscible block segment contains at least one or more alkylene oxide monomer units) and at least one epoxy resin immiscible block segment; and (c) a sufficient amount of a nitrogen-containing curing agent to cure the coating composition at ambient temperature of less than about 60° C. When the epoxy resin composition is cured, the toughness of the resulting cured epoxy resin composition is increased.

U.S. Pat. No. 6,887,574 is directed to and claims a curable flame retardant epoxy resin composition including (a) at least one flame retardant epoxy resin; (b) at least one amphiphilic block copolymer; and (c) a curing agent. Such components are present in the curable composition in the appropriate amounts and ratios such that, upon curing, the block copolymer self-assembles into a nano structure morphology, such as a worm-like micelle morphology. The resulting cured product is reported to have a remarkably increased high fracture resistance; and allows the use of flame retardant epoxies in applications where fracture resistance is an issue.

U.S. Patent Application Publication No. 2008/0287595 is directed to a composition comprising (1) a thermosettable resin selected from an epoxy resin, an epoxy vinyl ester resin, an unsaturated polyester resin or a mixture thereof, and (2) an amphiphilic mock copolymer dispersed in the thermosettable resin.

International Patent Publication No. WO 2010/008931 is directed to a structural composite that uses a block copolymer toughening agent to increase the fracture resistance (toughness) of the structural composite. The structural composite comprises (i) a carbon fiber reinforcing material and (ii) a thermosettable resin composition; wherein the thermosettable resin composition comprises (a) a thermosettable resin and (b) at least one block copolymer toughening agent.

International Patent Publication No. WO 2009/018193 is directed to curable compositions, cured compositions, and methods of forming the same, including an epoxy resin, a curing agent, an amphiphilic toughening agent, and an inorganic nanofiller, where the toughening agent forms a second phase having at least one dimension being on the nanometer scale.

The block copolymer may be used herein in an amount up to about 50 percent by weight, desirably from 5 to 40 percent by weight, based on the total weight of the adhesive composition.

The glass transition temperature (“Tg”) of the block copolymer should be above about 40° C. In one embodiment, the Tg of the block copolymer is between about 40° C. and about 155° C.

The Tg of a polymer is the temperature at which the polymer becomes brittle on cooling or soft on heating. More specifically, Tg defines a pseudo second order phase transition in which a polymer yields, on cooling, a glassy structure with properties similar to those of a crystalline material. Above Tg, the polymer becomes soft and capable of plastic deformation without fracture. While the Tg is occasionally described as the “softening temperature” of a polymer, it is not uncommon for the polymer to begin softening at a temperature below the Tg. This is because, due to the nature of many non-crystalline polymers, the softening of the polymer may occur over a temperature range rather than abruptly at a single temperature value. Tg generally refers to the middle point of this range even though the polymer may begin to soften at a different temperature. For purposes of this application, the Tg of a polymer refers to the value as determined by ASTM E-1356.

In addition to becoming brittle at temperatures below Tg, a polymer also generally becomes drier and less tacky than when that same polymer is heated to a temperature above its Tg. A tacky polymer will more readily adhere to a surface upon application of pressure alone than a non-tacky polymer. The importance of incorporating a copolymer that has a Tg above 40° C., and thus is dry or only slightly tacky at this point, will become more apparent by the discussion that follows.

### Other Additives

The Part B composition may contain additional additives, such as fillers, lubricants, thickeners, and coloring agents. The fillers provide bulk without sacrificing strength of the adhesive and can be selected from high or low density fillers.

Of particular interest are low density fillers, because the resulting final product has an otherwise lower density than a product without the filler, yet has essentially the same strength characteristics as if the filler was not present.

### Packaging and Mixing

Each of the Part A and Part B compositions are packaged in separate containers, such as bottles, cans, tubes, or drums.

The Part A and Part B compositions are mixed in a by volume ratio of about 3 to 50 to 1, such as about 5 to 20 to 1. Desirably, the by volume ratio is 10:1.

The mixing of the two parts can employ a mixing nozzle, which has fluid inputs for the two components, performs a suitable mixing operation, and dispenses the adhesive mixture directly onto the surface to be bonded. An example of a commercially available mixing and dispensing device is sold under the tradename MIXPAC, available from Sulzer Mixpac USA, Salem, N.H.

The two parts can also be mixed manually in a vessel, such as a bowl, bucket, or other container, but the operator needs to ensure that the mixing is thorough. As an aid to ensuring that mixing is complete, each part can be formulated with a dye or pigment, so that after mixing, a third color is formed. For example, one part may have a yellow dye, the other part may have a blue dye, so that after mixing, the complete adhesive composition will be green.

After mixing at room temperature, the composition demonstrates at least about 3 hours of open time and yet reaches its peak cure temperature (or, T_{PEAK}) within about less than one hour thereafter, as measured by a PICO Technologies USB TC-08 thermocouple data logger.

Also provided herein is a method of preparing a two-part adhesive composition. The method provides a first part comprising: (i) a (meth)acrylate component; and (ii) an amine; and provides a second part comprising: (i) a fatty acid peroxide.

In addition, provided herein is a method of bonding a first surface to a second surface. The method provides a two part composition comprising: (a) a first part comprising: (i) a (meth)acrylate component; and (ii) an amine; and (b) a second part comprising: (i) a fatty acid peroxide, mixes the first part and the second part, applies the mixed composition to at least one of the first surface or the second surface, mates the first surface and the second surface with the mixed composition between the two mated surfaces, and allows the composition to cure and bond the first surface with the second surface.

In these methods, the first part and second are mixed in a ratio of 0.5 to 15 parts of the Part A composition to 1 part of the Part B composition by volume.

### EXAMPLES

### Example 1—Part A Composition

In Table 1 Part A, a model Part A composition was prepared from the constituents listed in the noted amounts.

TABLE 1
Part A

| Constituent | Amt (grams) |
|---|---|
| Methyl methacrylate | 45.95 |
| EDTA | 0.1 |
| Triphenylphosphine | 0.5 |
| Hydroquinone | 0.05 |
| BLENDEX 338 | 4.5 |
| KRATON D 1155 ES | 22 |
| HYPRO RLP 2000 X 168 VTB | 13 |
| Wax | 0.4 |
| Methacrylic acid | 10 |
| Hydroxyl ethyl methacrylate | 1 |
| phosphate ester | |
| AEROSIL 200 | 1 |

In Table 2 Part A, three Part A compositions are shown: Sample No. 1 (Control) represents the composition from Table 1 Part A, in which 2 percent by weight of p-diethanol amine toluene (p-DEA) is included in the Table 1 Part A composition; Sample No. 2 represents the composition from Table 1 Part A, in which 2 percent by weight of THQ-CN is added to 98 percent by weight of the Table 1 Part A composition; and Sample No. 3 represents the composition from Table 1 Part A, in which 2 percent by weight of THQ-NO₂ is added to 98 percent by weight of the Table 1 Part A composition.

TABLE 2
Part A

| | Sample No./Amt (Wt %) | | |
|---|---|---|---|
| Constituents | 1 | 2 | 3 |
| Part A from Table 1 | 98 | 98 | 98 |
| p-DEA | 2 | 0 | 0 |
| THQ-CN | 0 | 2 | 0 |
| THQ-NO2 | 0 | 0 | 2 |

### Example 2—Part B Composition

In Table 1 Part B, a model Part B composition was prepared from the constituents listed in the noted amounts.

TABLE 1
Part B

| Constituents | Amt (grams) |
|---|---|
| PLURACOL V 10 | 10 |
| BENZOFLEX 2088 | 20.4 |
| Bisphenol A epichlorohydrin resin | 21 |
| ECONOPOLY 2 N 1 | 11.5 |
| VOSSEN BLAU 750 LS | 0.1 |

In Table 2 Part B, three compositions are shown: Sample No. 1 represents the composition from Table 1 Part B, in which 37 percent by weight of benzoyl peroxide is added to 63 percent by weight of the Table 1 Part B composition; Sample No. 2 represents the composition from Table 1 Part B, in which 37 percent by weight of lauroyl peroxide is added to 63 percent by weight of the Table 1 Part B composition; and Sample No. 3 represents the composition from Table 1 Part B, in which 37 percent by weight of lauroyl peroxide is again added to 63 percent by weight of the Table 1 Part B composition.

TABLE 2
Part B

| | Sample No./Amt (Wt %) | | |
|---|---|---|---|
| Constituents | 1 | 2 | 3 |
| Part B from Table 1 | 63 | 63 | 63 |
| Benzoyl Peroxide | 37 | 0 | 0 |
| Lauroyl Peroxide | 0 | 37 | 37 |

### Example 3—Mixing

The Part A and B compositions from Table 2 were mixed together in a vessel in a by volume ratio of 10:1 and into the mixed composition a PICO Technologies USB TC-08 thermocouple data logger was placed so that reactivity measurements of temperature and time could be recorded. Some of the measurements are captured in Table 3.

The composition was also applied to an anodized aluminum lap shear coupon and mated to another anodized aluminum lap shear coupon with 0.5″ overlap. The coupons were placed evaluated for fixture time. Fixture time measurements are also recorded in Table 3.

TABLE 3

| Physical | Sample No. | | |
|---|---|---|---|
| Properties | 1 | 2 | 3 |
| Peak Exotherm | 10 | 232 | 198 |
| Time (Tₚₑₐₖ) , min | | | |
| Peak Exotherm | 135 | 121 | 122 |
| Temperature, ° C. | | | |
| Fixture Time, | 8 | 180 | |
| min | | | |

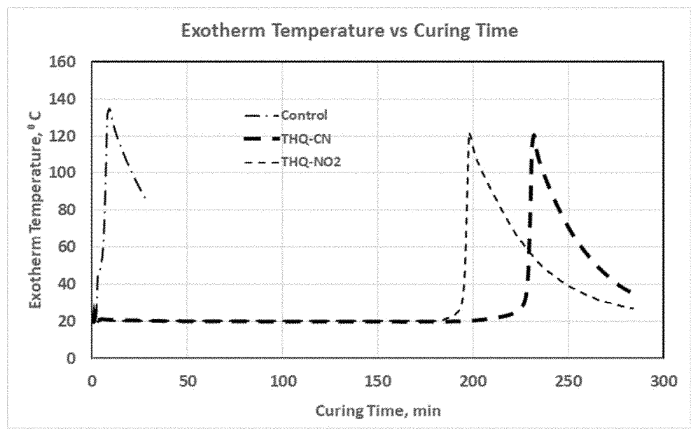

Other measurements are shown in FIG. 1. In FIG. 1, data is accumulated every minute to show the time required for the onset of cure (or, T_{ONSET}), the peak exotherm temperature (or, T_{PEA}) at which, and time for which the overall cure profile to develop.

As can be seen, for the control sample (Sample No. 1), T_{ONSET} begins in about 1 to about 2 minutes after mixing and develops a T_{PEAK} in about 7 to about 8 minutes. In contrast, Sample No. 2 requires nearly 4 hours (between about 202 and 230 minutes) for T_{ONSET} to begin and develops a T_{PEAK} in about 231 to about 233 minutes. And Sample No. 3 requires over 3 hours (between about 181 and 198 minutes) for T_{ONSET} to begin and develops a T_{PEAK} in about 199 to about 201 minutes.

What is claimed is:

1. A two part curable composition comprising:
(a) a first part comprising:
(i) a (meth)acrylate component;
(ii) an amine; and
(b) a second part comprising:
(i) a fatty acid peroxide.

2. The composition of claim 1, wherein when the Part A composition and the Part B composition are mixed together the composition demonstrates at least about 3 hours of open time and yet cures afterward in less than about 60 minutes, as measured by a PICO Technologies USB TC-08 thermocouple data logger.

3. The composition of claim 1, wherein the Part A composition further comprises at least one of a vinyl terminated polybutadiene in liquid form at room temperature; a reactive acid component; a 1,4-quinone and triaryl or alkaryl phenylphosphine.

4. The composition of claim 3, wherein the 1,4-quinone is napthoquinone, benzoquinone and derivatives thereof.

5. The composition of claim 3, wherein the 1,4-quinone is present in an amount less than or equal to about 0.05 percent by weight.

6. The composition of claim 3, wherein the triaryl or alkaryl phenylphosphine is present in an amount greater than or equal to about 0.5 percent by weight.

7. The composition of claim 1, wherein the (meth)acrylate component of the Part A composition is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(meth)acryloyloxypropyl trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

8. The composition of claim 1, wherein the amine is selected from 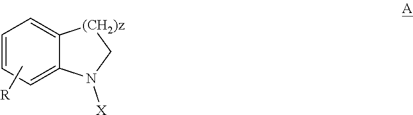
wherein R is optional but when present may be present 1-4 times and may be chosen from C₁₋₅ alkyl, which may be interrupted by one or more hereto atoms and/or functionalized by halogen, —OH, —COOH, —CN, —NH₂ or —NO₂; halogen; —OH; —COOH; —CN; —NH₂ or —NO₂; X is C₁₋₅ alkyl or C₇₋₂₀ alkaryl, either of which may be interrupted by one or more hereto atoms, and which are functionalized by at least one electron withdrawing groups such as —CN or —NO₂; and z is 1-3.

9. The composition of claim 1, wherein the amine is selected from

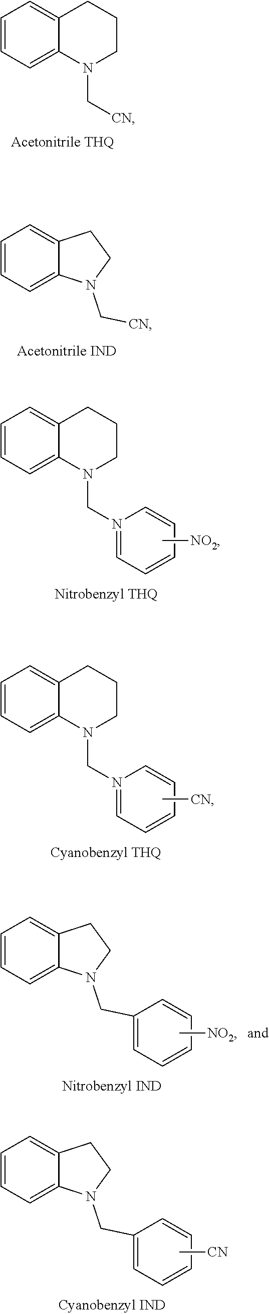

10. The composition of claim 3, wherein the reactive acid component is sulphonic acid or a sulphonic acid derivative.

11. The composition of claim 3, wherein the reactive acid component is selected from the group consisting of phosphoric acid, phosphoric acid derivative, and phosphate ester.

12. The composition of claim 3, wherein the reactive acid component is hydroxyl ethyl methacrylate phosphate ester.

13. The composition of claim 1, wherein the fatty acid peroxide has about 8 carbon atoms to about 18 carbon atoms.

14. The composition of claim 1, wherein the fatty acid peroxide is a member selected from lauroyl peroxide, didecanoyl peroxide, dimyristyl peroxydicarbonate and dicetyl peroxydicarbonate.

15. The composition of claim 1, further comprising an epoxy resin in the Part B composition.

16. The composition of claim 15, wherein the epoxy resin of the Part B composition is selected from the group consisting of cycloaliphatic epoxides, epoxy novolac resins, bisphenol-A epoxy resins, bisphenol-F epoxy resins, bisphenol-A epichlorohydrin based epoxy resin, alkyl epoxides, limonene dioxide, polyfunctional epoxides, and combinations thereof.

17. The composition of claim 15, wherein the epoxy resin of the Part B composition is a liquid bisphenol A epichlorohydrin epoxy resin.

18. A method of preparing a two-part adhesive composition comprising:
(a) providing a first part comprising:
(i) a (meth)acrylate component; and
(ii) an amine; and
(b) providing a second part comprising:
(i) a fatty acid peroxide.

19. A method of bonding a first surface to a second surface, comprising:
providing a two part composition comprising:
(a) a first part comprising:
(i) a (meth)acrylate component; and
(ii) an amine; and
(b) a second part comprising:
(i) a fatty acid peroxide,
mixing the first part and the second part,
applying the mixed composition to at least one of the first surface or the second surface,
mating the first surface and the second surface with the mixed composition between the two mated surfaces, and
allowing the composition to cure and bond the first surface with the second surface.

20. The method of claim 18, wherein the Part A composition and the Part B composition are mixed in a ratio of 0.5 to 15 parts of the Part A composition to 1 part of the Part B composition by volume.
